(19) United States
(12) Patent Application Publication
(10) Pub. No.: US 2002/0121548 A1
(43) Pub. Date: Sep. 5, 2002

(54) Hand held client system with an external storage meduim

(76) Inventor: Ho-Lung Lu, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/797,561

(22) Filed: Mar. 5, 2001

(51) Int. Cl. G06K 7/00

(52) U.S. Cl. 235/440

(57) ABSTRACT

A hand held client system with an external storage medium comprises a storage body and a hand held client system. The storage body is installed with a docking station as an interface, and one end thereof is installed with a slot for being inserted by a floppy disk for storing data or files. The hand held client system is installed with a connecting port and is inserted into the docking station of the storage body for data-communicating with storage body. A control circuit is built in the storage body for controlling the bidirectional transmission of data or files between the storage body and the hand held client system so as to read, write or delete data or files.

### FIELD OF THE INVENTION

The present invention relates to a hand held client system with an external storage medium, and especially to device which integrates the function of a storage body and a hand held client system for performing a bidirectional transmission therebetween. The hand held client system reads, writes, and deletes the data in the storage medium.

### BACKGROUND OF THE INVENTION

The prior art hand held client systems, such as personal digital assistants or packet type computers, are used to record some notes and are frequent connected to other interface for data communication. Therefore, the personal digital assistants have connecting ports or infrared transceivers for linking. However, for large amount of data, since the memory of the hand held client system is finite and some personal digital assistants do not be installed with expanding slots. Therefore, how to copy a standby data in various environments is a critical problem. In general, to standby a copy of data through a general used floppy disk drive inserted with a disk, a CF reader (compact flash reader) inserted by a CF card, SM reader (smart media reader) inserted by a SM card; is a well known operation. However, in the present invention, the disk drive is independent from a hand held client system. No application which combines a hand held client system and a floppy disk drive, a CF reader or a SM reader is developed for used in the data transmission.

### SUMMARY OF THE INVENTION

In order to improve aforesaid defects in the prior art, the present invention provides a hand held client system with an external storage medium, wherein the hand held client system is inserted into a docking station of a storage body so that the two may be combined for data transmission.

To achieve the object, the present invention provides a hand held client system with an external storage medium comprising a storage body and a hand held client system. The storage body is installed with a docking station as an interface, and one end thereof is installed with a slot for being inserted by a floppy disk for storing data or files. The hand held client system is installed with a connecting port and is inserted into the docking station of the storage body for data-communicating with the storage body. A control circuit is built in the storage media for controlling the bidirectional transmission of data or files between the storage body and the hand held client system so as to read, write or delete data or files.

The various objects and advantages of the present invention will be more readily understood from the following detailed description when read in conjunction with the appended drawing.

### BRIEF DESCRIPTION OF THE DRAWINGS

FIG. 1 is an exploded perspective view of the back side of the present invention.

FIG. 2 is a front exploded perspective view of the present invention.

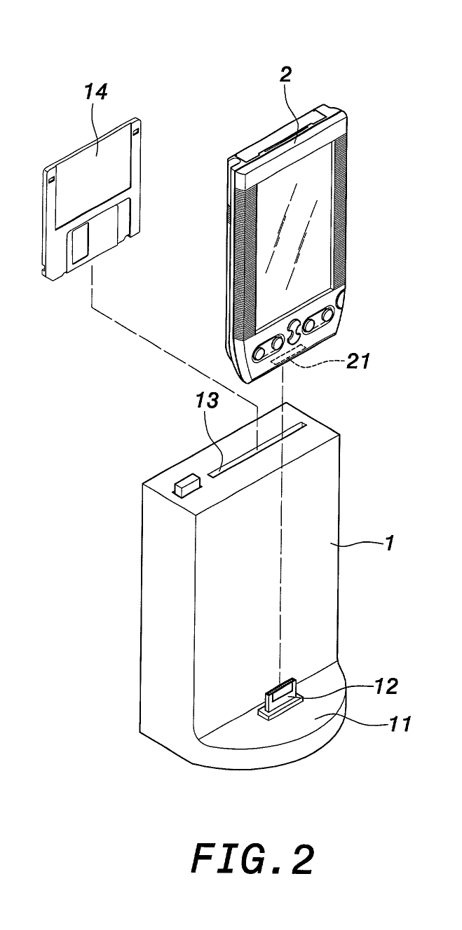

FIG. 3 is an assembled perspective view of the present invention.

FIG. 4 shows an operational flow process of the present invention.

FIG. 5 is an exploded perspective view of the second embodiment of the present invention.

FIG. 6 is an assembled perspective view of the third embodiment of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

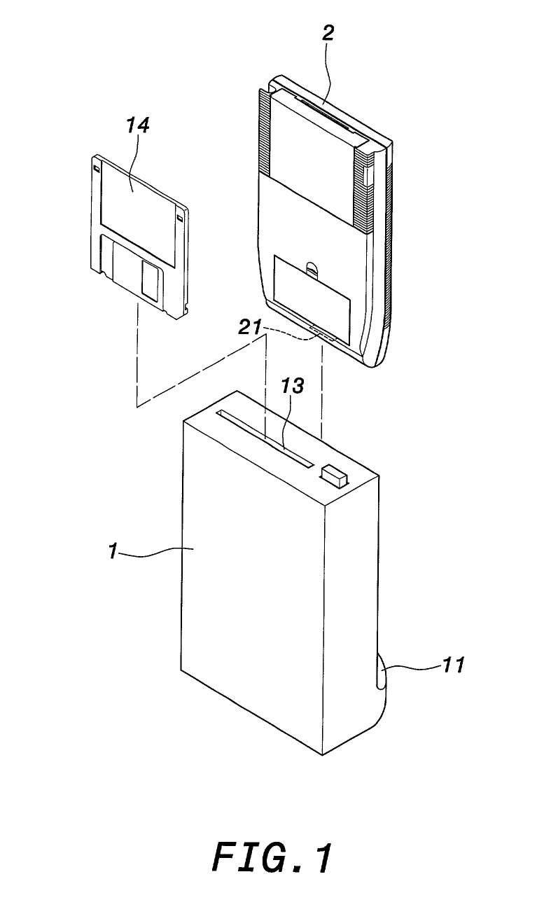

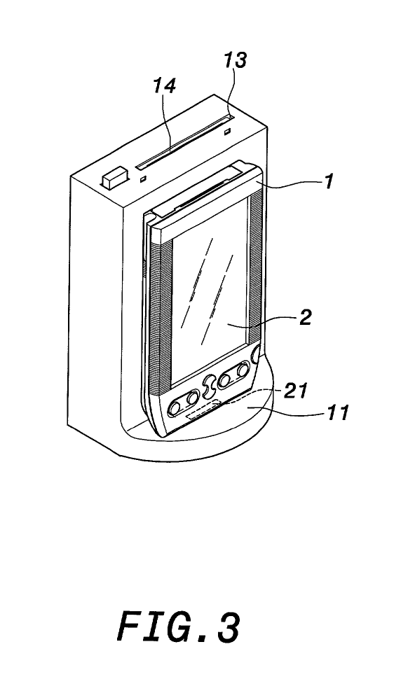

With reference to FIGS. 1 and 3, the first embodiment of the present invention is illustrated herein. The hand held client system with a storage medium of the present invention includes a storage body 1 and a hand held client system 2.

The storage body 1 is a floppy disk drive. The rear end thereof has an approximate cambered seat 11. The body 1 can be placed uprightly. A docking station 12 is installed adjacent to the seat 11. The docking station is an expanding interface. One end of the body 1 is installed with a slot 13 for being inserted by a storage device 14 for storing data or files. The storage device 14 may be a floppy disk. The power of the storage body 1 may be from a battery or through a power adaptor for being connected to an alternative power source or to a power source of the hand held client system.

The hand held client system 2 may be a personal digital assistant or a pocket type computer. A bottom thereof is installed with a connecting port 21 so as to be inserted to the docking station 12 of the storage body 1. Therefore, the storage body 1 is used a base. By the control circuit 22 of the storage media, the bidirectional transmission and control of the floppy disk drive stored in the storage device 14 of the storage body 1 is processed through the control circuit 22 of the storage media so as to perform the function of reading, writing, or deleting the data or files.

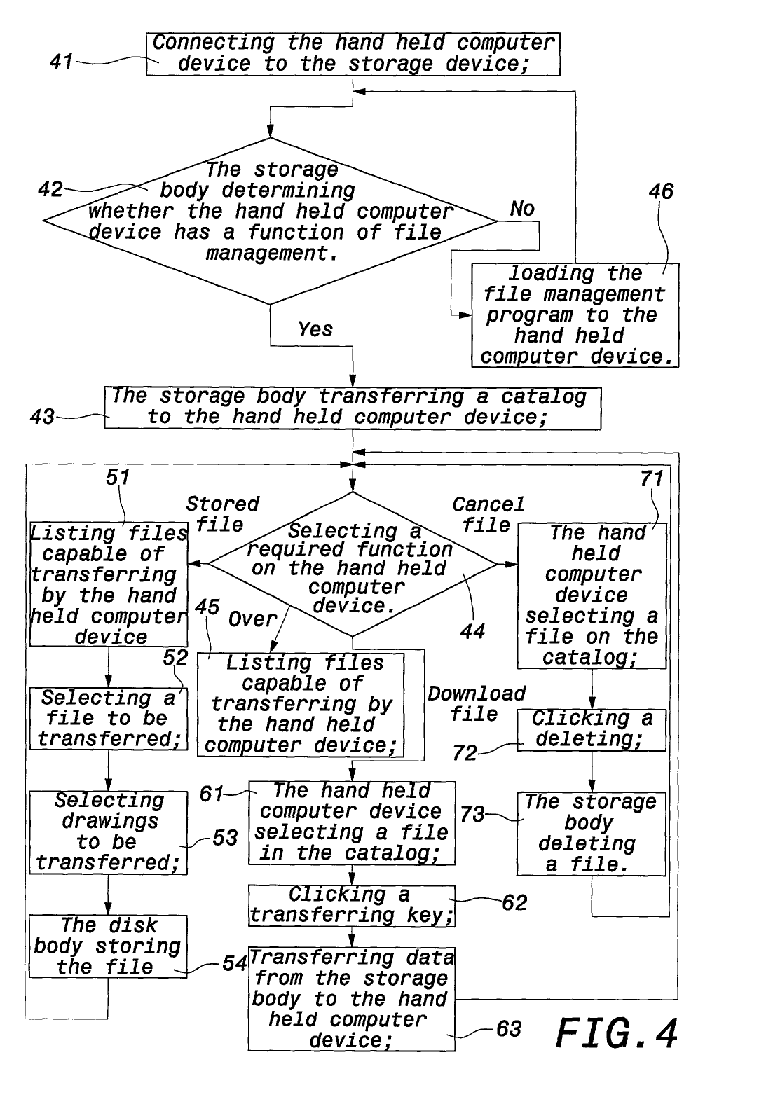

With reference to FIG. 4, the operation flow of the present invention is illustrated. The process includes the following steps:

Step 41: Connecting the hand held client system to the storage device;

Step 42: The storage body determining whether the hand held client system has a function of file management, if no, loading the file management program to the hand held client system (step 46); and then, the process returns to step 41;

Step 43: the storage body transferring a catalog to the hand held client system;

Step 44: selecting a required function on the hand held client system; if a stored file is selected, then, the process jumps to step 51; if loading a file is selected, then the process jumps to step 61; if deleting a file is selected, then the process jumps to step 71; otherwise the storage body enters into an idle mode (step 45);

Step 51: listing files capable of transferring by the hand held client system;

Step 52: selecting a file to be transferred;

Step 53: selecting drawings to be transferred;

Step 54: the disk body storing the file and then the process returning to step 44;

Step 61: the hand held client system selecting a file in the catalog;

Step 62: clicking a transferring key;

Step 63: transferring data from the storage body to the hand held client system, and then the process returning to step 44;

Step 71: the hand held client system selecting a file on the catalog;

Step 72: clicking a deleting;

Step 73: the storage body deleting a file and the process returning to step 44.

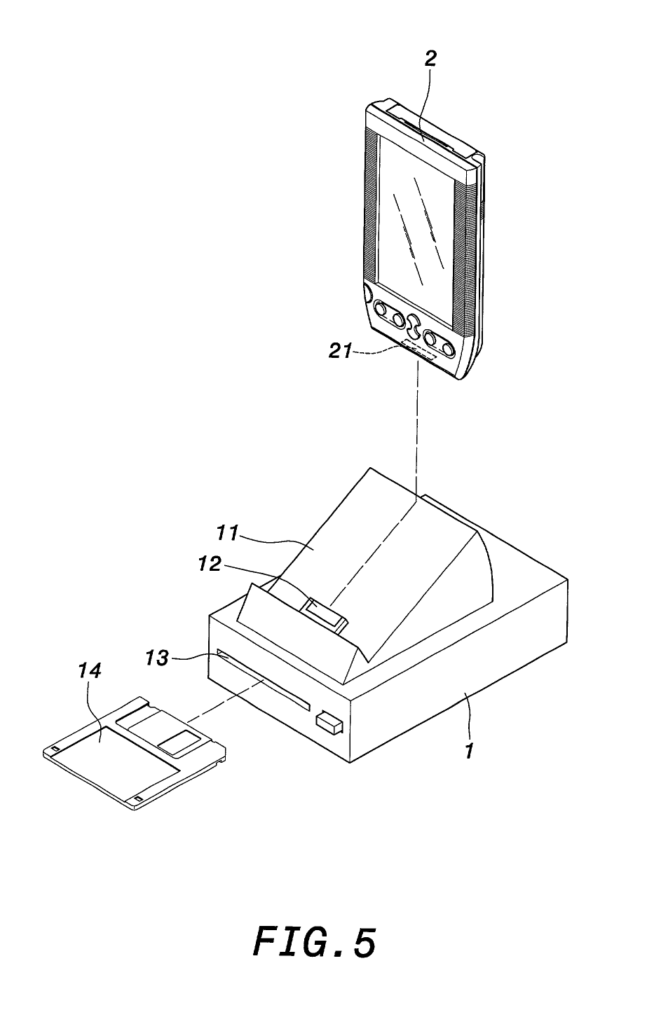

With reference to FIG. 5, the second embodiment of the present invention is illustrated. The top of the storage body is installed with a protruded seat 11. A docking station 12 is formed adjacent to the seat 11.

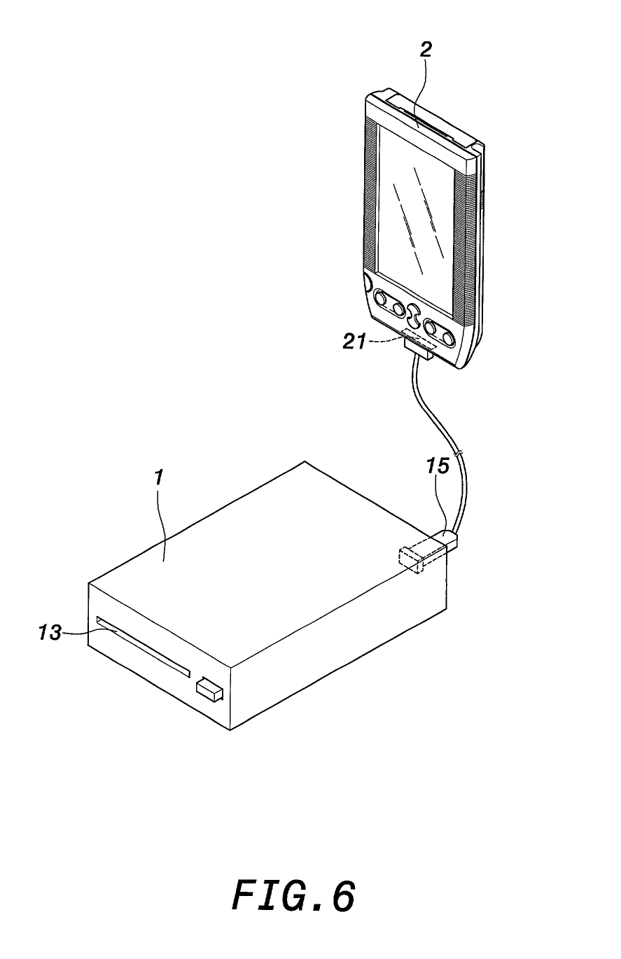

With reference to FIG. 6, the third embodiment of the present invention is illustrated. In this embodiment, a lower end of the storage body 1 is installed with a connecting port 17 so as to be connected to the connector 16, and then is further connected to the connecting port 23 of the hand held client system 2. The first connecting port 17 is matched to the second connecting port 23, and these connecting ports may be ports of series USB connecting ports or series RS-232 ports. Thereby, data can be communicated between the storage body 1 and the hand held client system 2. The control circuit 22 in the handle held computer device 2 is used to process the bidirectional transmission of data or files therebetween so as to perform the function of reading, writing, or deleting the data or files.

The above storage body is a CF reader or a SM reader, and the storage device is a CF card or a SM card.

Therefore, the hand held client system with an external storage medium of the present invention has the following advantages:

1. The data is bidirectionally transmitted between the storage body and the hand held client system.

2. The present invention has the function of reading, writing and deleting data or files.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hand held client system with an external storage medium comprising:
a storage body installed with a first interface unit, one end thereof being installed with a slot for being inserted by a storage body for storing data or files; and
a hand held client system installed with a second interface unit which is connected to the first interface unit of the storage body for data-communicating with the storage body.

2. The hand held client system with an external storage medium as claimed in claim 1, wherein the storage body is selected from one of a group containing a floppy disk drive, a compact flash reader, and a smart media reader.

3. The hand held client system with an external storage medium as claimed in claim 1, wherein the first interface unit is a docking station or a connector.

4. The hand held client system with an external storage medium as claimed in claim 1, wherein the storage body is a seat.

5. The hand held client system with an external storage medium as claimed in claim 4, wherein the seat is installed at a rear end or a top end of the storage body.

6. The hand held client system with an external storage medium as claimed in claim 1, wherein power of the storage body is from a battery or through a power adaptor for being connected to an alternative power source or to a power source of the hand held client system.

7. The hand held client system with an external storage medium as claimed in claim 1, wherein the storage medium is selected from one of a group containing a floppy disk, a CF card and a SM card.

8. The hand held client system with an external storage medium as claimed in claim 1, wherein the hand held client system is selected from one of a group containing a personal digital assistant and a pocket type computer.

9. The hand held client system with an external storage medium as claimed in claim 1, wherein the second interface unit is an adapting port.
